(19) United States
(12) Patent Application Publication
(10) Pub. No.: US 2006/0087410 A1
(43) Pub. Date: Apr. 27, 2006

(54) Facility access control system including temporary personnel identification badges with expiration indicia

(75) Inventors: Luis Garcia, Slinger, WI (US); Bryan D. Dickerson, Hartford, WI (US); Ian Davison, Cedarburg, WI (US)

Correspondence Address: QUARLES & BRADY LLP, 411 E. WISCONSIN AVENUE, SUITE 2040, MILWAUKEE, WI, 53202-4497, US

(73) Assignee: API Software, Inc.

(21) Appl. No.: 10/974,061

(22) Filed: Oct. 27, 2004

(51) Int. Cl. G08B 1/00

(52) U.S. Cl. 340/309.16

(57) ABSTRACT

An identification badge is provided for issuance to a transient person requiring temporary access to a facility for a defined period of time. The badge includes a picture of the transient person, an element that encodes machine readable data identifying the transient person, and a designation of a class of transient people, such as a visitor or temporary worker for example. A facility access system that employs the badge has devices for reading the element and using the data obtained thereby to unlock doors or record the arrival and departure of the person. An indicia on the badge visibly changes in appearance after the defined period of time to indicate expiration of the badge.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to personnel identification badges that incorporate a mechanism for activating locks on doors and gates to secure areas of the building, and more particularly to such badges for issuance to people requiring temporary access to the building.

2. Description of the Related Art

It is a common practice to issue identification badges to employees at a facility, such as a hospital, office building, factory, military base, or amusement park for example. The badges often are imprinted with a photograph and the name of the employee. The badge may be worn on the person so as to be visible by others. The badge frequently has an element, such as a bar code, a magnetic stripe or a radio frequency transponder, which encodes information that identifies the particular employee. The element can be used to activate door locks in the facility, thereby allowing the person to enter areas that are otherwise secured from entry by unauthorized persons. Typically, the encoded information includes a unique number assigned to that employee and a lock control system contains a list of those employees who are authorized to enter a particular door. For example, the lock on a door to a computer equipment room may be activated only by the badges of employees in the information technology department who have a need to enter that room. The employee identification number, the date and time, and a door number can be stored in the lock control system as a record who entered a secured area of the facility.

The employee badges also may be utilized with a time and attendance system. Upon entering and exiting the facility, hourly workers swipe their badges through a device that reads the bar code or magnetic stripe. This process obtains the employee's identification number, thereby indicating when that person commences and terminates each work shift. The employee identification number and the current time are recorded in a computer system and subsequently used to calculate the number of hours that the employee worked during a given pay period and the wages to which the employee is entitled.

Contractors, workers from temporary staffing agencies, volunteers, and other short term laborers, collectively referred to as “temporary workers”, also require access to the company's facilities at certain times. Some temporary workers may require facility access for only one day while others may work at the facility for one or more weeks. These temporary workers may be issued similar identification badges as those for regular employees. When the temporary worker finishes the job, the badge is surrendered, so that the person no longer may access the facility. A badge for a temporary worker may not contain the photograph or name of particular person, so that it can be reused for subsequent workers. In other cases, the temporary worker badge includes the photograph and name of the person to whom it is issued. Either type of temporary worker badge may have identification information encoded in a machine readable element that is valid only for the time period that the person us working at the facility. Thereafter the identification information is deleted from the lock control system or other form of building access control system.

Visitors to a facility often are required to wear badges which clearly identify that individual as a visitor. Such badges usually do not provide a mechanism for unlocking doors because the person must remain in public areas of the building, unless being escorted by an employee. Visitor badges typically are surrendered when the person exits the facility. Some visitor badges are reusable, while others are disposable. The disposable badges may include an area in which the receptionist writes the date on which the badge is issued, or the badge may be colored coded to indicate the day of validity. These mechanisms prevent a badge from being reused in an unauthorized manner.

It is desirable to provide a common badge system for different classes of individuals, such as visitors, temporary workers and others, who will be present at a facility only for a relatively short period of time. However the length of that period varies depending upon the nature of the business that a particular person has at the facility. It is further desirable to prevent authorized use of the badge upon the expiration of that period of time.

### SUMMARY OF THE INVENTION

A facility access system admits a person to a facility for a defined period of time. This system is comprised of a badge with an element that encodes data, which is machine readable, and indicia that upon being activated visibly changes in appearance after the defined period of time to indicate expiration of the badge. The element, such as a barcode or magnetic stripe for example, can be scanned by a reader of the facility access system to obtain the encoded data. That data may identify the particular person to whom the badge was issued or a class of people in which the person is a member.

In one embodiment of the facility access system, the data obtained by the reader is employed to unlock a door to enable the person to access a restricted area of the facility. Only specific individuals or a class of people may so access that restricted area. The visible change in appearance of the indicia after the defined period of time may render the element unreadable and thus unable to unlock doors or otherwise access the facility. In another embodiment, the data obtained by the reader is sent to a time and attendance program executed by a computer which records the arrival and departure of workers at the facility to calculate the amount of time that they work and thus the wages that they have earned.

Another aspect of the present invention provides a picture on the badge of the person to whom the badge is issued. The badge also may include a designation of the class of transient people, such as a visitor, contractor, volunteer, or temporary employee for example, in which the particular person is a member. These features of the badge enable other personnel at the facility to readily identify the authority of the person carrying the badge to access specific areas of the facility and the appearance of the indicia indicates when that authority expires.

### BRIEF DESCRIPTION OF THE DRAWINGS

FIG. 1 is a diagram of a facility access system for issuing identification badges, controlling access to different areas of a facility, and gathering time and attendance information;

FIG. 2 is an exemplary identification badge for transient people;

FIG. 3 is an edge view of the identification badge;

FIG. 4 is an enlarged section of a surface of the identification badge showing a pre-printed pattern; and

FIG. 5 illustrates a transient person identification badge which has expired.

### DETAILED DESCRIPTION OF THE INVENTION

A facility access control system is being described for use in a hospital, however it should understood that this type of system can be utilized in a wide variety of facilities for diverse classes of individuals who require access to different areas of the facility for various periods of time.

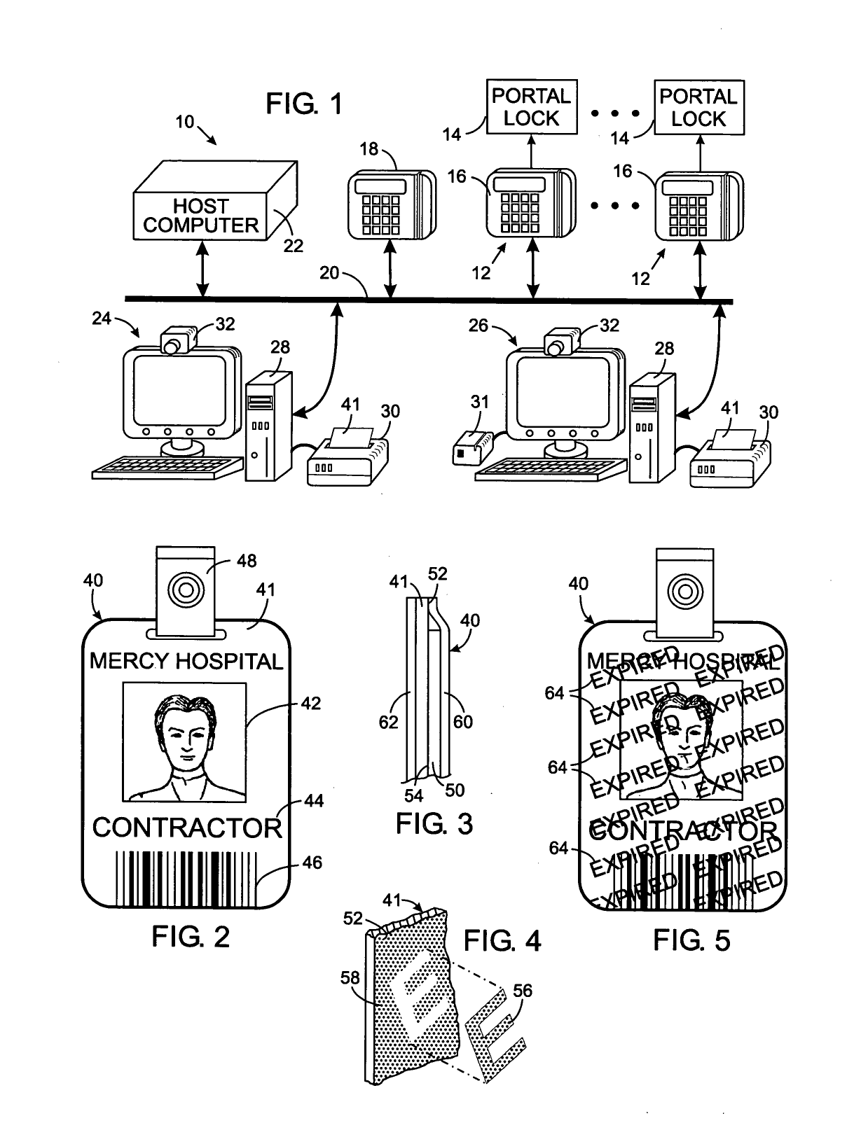

With initial reference to FIG. 1, a facility access control system 10 comprises a plurality of portal control circuits 12, each operating a different lock 14 of a building door, fence gate or similar portal. Each portal control circuit 12 includes a badge reader 16 or other data input device into which a person desiring to pass through the portal enters information used to indicate their authority to access that portion of the building. Each badge reader 16 also includes a keypad that an be used to manually enter an access code. The badge readers 16 are connected to a communication network 20 for the facility at which the access control system 10 is installed. The communication network 20 connects to a host computer 22 which executes a plurality of software programs to perform different security related tasks. For example, the host computer 22 executes a program that supervises the activation of the door locks 14 in response to access codes entered into the badge readers 16.

When entry through a locked door is desired, the person swipes his or her identification badge through the badge reader 16 located adjacent the door. The badge reader 16 thereby obtains an identification number which has been encoded on either a barcode, a magnetic stripe, radio frequency transponder, or other machine readable element on the identification badge. The identification number may designate particular individual, a class of people, or the areas of the facility that the cardholder can access. The badge reader transmits the identification number to the host computer 22 along with a request to authenticate that this person is authorized to enter the particular door. The host computer 22 looks up the identification number in its memory to determine where it indicates authorization to pass through the associated door. If this particular person is authorized to enter this door, the host computer 22 sends an approval message to the badge reader 16 which responds by activating the corresponding door lock 14. Otherwise the badge reader 16 either does not receive a reply message from the host computer 22 or receives an access denied message. Alternatively, the list of identification numbers authorized for a given door can be stored in the badge reader 16 associated with that door and the entry verification is performed by the badge readers.

The host computer 22 also records the arrival and departure times of employees and other workers at the facility for use by time/attendance and payroll programs. For this purpose, additional badge readers 18 are provided at unlocked building entry points, such as reception areas. Upon entering and exiting the building, the employees swipe their identification badges through a reader 16 or 18 which thereby obtains a unique identification number for each employee upon commencing and terminating a work period. The employee identification number along with the current time of day are transmitted to the host computer where that information is stored.

Either the host computer or another computer at the facility that is connected to the network 20 utilizes the entry and exit information to calculate the amount of time each employee worked at the facility and ultimately the amount of pay that the person has earned. Any of a variety of conventional programs for recording time and attendance data and calculating payrolls can be utilized, such as programs available from API Software, Inc. of Hartford, Wis. U.S.A.

The identification badges are produced at one of a plurality of workstations 24 and 26, that each comprise a personal computer 28 to which a video camera 32 and a badge printer 30 are connected. For example, a first workstation 24 is located in the human resources department of the company and used during processing new employees and volunteers. A second workstation 26 is located at the reception desk in the main lobby of the facility for processing visitors and other people requiring temporary access to the premises. Additional workstations can be provided at other locations, such as in the security booth at a loading dock to process contractors and delivery persons requiring temporary facility access.

For example, the reception area of a hospital processes transient people who will be in the building for a relatively short of period of time. Classes of transient people include patients, persons visiting patients, volunteers, employees, and temporary workers such as contractors installing, repairing and maintaining equipment. Each class of transient people needs access to different areas of the hospital and thus require different levels of access authority. Specifically, a visitor of an employee or patient should be prohibited from entering any area that is secured by a locked door. Temporary workers and volunteers may be permitted access only to those secured areas that are necessary to perform their specific functions, in which case the building access areas are specifically defined for each temporary worker. In other words, one temporary worker may require access to the hospital pharmacy, to which other temporary workers are prohibited from entering.

Upon entering the hospital, transient people identify themselves and specify the nature of their business to a security guard or receptionist, who responds by preparing a temporary identification badge for the transient person to use while on the premises.

The temporary identification badge is made on a workstation 26 by selecting a badge preparation software program. The class of the transient person, e.g. visitor, contractor, temporary employee, etc., is entered into the computer and the camera 32 is used to acquire an image of the person. If the transient person is a temporary worker requiring access to restricted areas of the hospital, a designation of those areas also is entered into the computer. That designation take a number of forms, one of which comprises designating the type of temporary worker, for example a physician, a floor nurse, a surgical nurse, or a business office worker. Access to different areas of the hospital is associated with each type of temporary worker. For example, a temporary floor nurse will be granted access to doors in areas with patient rooms, a temporary surgical nurse can access the surgical suites, and temporary office employee only can enter the appropriate office areas of the hospital. Alternatively, building access can be designated into the computer by individually selecting the areas of the hospital into which that specific transient person may enter.

Upon completing the data entry phase of the identification badge preparation process, the software executed on the personal computer 28 creates an paper identification card 41 on the printer 30. The identification card 41 comprises both pre-printed information, such as the hospital name, logos and a colored background, and information printed by the workstation 26. FIG. 2 depicts an exemplary temporary personnel badge 40 formed using the completed identification card 41. A picture 42 of the transient person, produced from the image required by a camera 32, has been printed on the identification card along with a designation 44 of the class of transient person, e.g. a contractor. Alternatively, a photograph or other likeness of the person can be adhered to the identification card 41. A bar code 46, forming an element encoding an identification number for this person, also is printed on identification cards 41 for those classes of transient people who are authorized to unlock doors within the hospital. A unique identification number also can be assigned to other classes of transient people, such as visitors, in order to subsequently obtain information about a given person that was recorded in the computer upon entering the premises. Alternatively, the identification number can be encoded on a magnetic stripe located on the back surface of the identification card 41, in which case the card is swiped through a magnetic writing device 31 connected to the personal computer 28. A radio frequency transponder or other machine readable component can be used as the element of the badge that encodes the identification number.

The paper identification card 41 then is removed from the printer 30 and laminated to form the identification badge shown in FIGS. 2 and 3. The person issuing the temporary personnel identification badge 40 first places a transparent overlay 50 against the front surface 52 of the identification card 41 on which the picture and other information have been printed. The abutting surfaces of the identification card 41 and the overlay 50 contain chemical agents that react over time to change the appearance of the identification badge 40 to thereby indicate its expiration.

With additional reference to FIG. 4, a first chemical agent is applied to the front surface 52 of the identification card 41 in a pattern 56 of dots or other geometric shapes which form the letters of the word “EXPIRED.” The first chemical agent is either initially invisible to the human eye, or has a color that matches the color of dots of conventional ink which are applied to the remaining background area 58 of the identification card's front surface 52. Thus when the identification card 41 is issued the dot pattern of the first chemical agent in indistinguishable from the background of the front surface 52 and the temporary personnel identification badge 40 appears as shown in FIG. 2.

The surface 54 of the overlay 50 which abuts the printed front surface 52 of the identification card 41 has a second chemical agent applied thereto. When these coated surfaces contact each other, the first and second chemical agents react to cause a visibly perceptible change after a predefined interval of time. At the completion of that reaction interval, the dot pattern 56 of the first chemical area changes to a color that contrasts with the color of the untreated background area 58 of the identification card 41. This color change results in the words EXPIRED 64 becoming visible on the face of the temporary personnel identification badge 40, as illustrated in FIG. 5. It should be understood that the pattern 56 can define other words that similarly indicate expiration of the identification badge 40.

When the temporary personnel identification badge 40 is issued to a transient person, the issuer selects a particular overlay 50 that has a second chemical agent with a reaction time that corresponds to the duration that the person requires access to the hospital. The reaction time is typically one or two hours for a patient visitor and may be eight hours, the length of a work shift, for a temporary worker. Overlays 50 may be provided having longer reaction times for use with temporary workers who will be at the facility for longer periods. The reaction times do not have to be precisely the amount of time that the particular person is to have access to the facility provided that it is at least the desired interval and not significantly longer. The overlays 50 of each different reaction time period are stored in separate containers at the point of issuance and may have different colored removable backers to indicate the reaction time of the second chemical agent thereon.

If a particular transient person requires access to the facility for an interval of time which does not correspond to the predefined reaction times of any of the overlays, an overlay with a slightly longer reaction time may be used for the identification badge. Alternatively, an overlay with a shorter interval can be selected, thereby necessitating that the person obtain a subsequent identification badge upon the expiration of the first badge that is issued.

After the overlay 50 has been applied to the identification card 41, a transparent outer layer 60 is adhesively applied to the opposite surface of the overlay 50. This secures the overlay 50 to the identification card 41 and protects the front of the temporary personnel identification badge 40. However, the overlay 50 may be adhered directly to the identification card 41 thus eliminating the need for an outer layer 60. In this latter case, the relatively short life of the temporary personnel identification badge 40 does not require further protection. Another transparent outer layer 62 optionally may be applied to the rear surface of the identification card 41 for longer term protection. The laminated temporary personnel identification badge 40 then is given to the transient person.

The transient person wears the issued temporary personnel identification badge 40 so that it is clearly visible to other people in the hospital. A spring loaded clip 48 is provided to attach the badge to the person's clothing. For temporary workers who have authority to open doors to certain areas of the hospital, the person can swipe the badge 40 through the badge reader 16 of the appropriate portal control circuit 12 to activate the corresponding door lock 14. In doing so, the badge reader 16 reads the badge's indicia, such as bar code 46, which encodes the temporary worker's identification number to determine whether the door should be unlocked.

When the temporary personnel identification badge 40 expires, the reaction of the first and second chemical agents progresses to the point where the dot pattern 58 changes color and becomes visibly different than the background area 56. As a result, the words “EXPIRED” 64 appear on the face of the temporary personnel identification badge 40 shown in FIG. 5. Other patterns of dots can be placed used to render the bar code 46 unreadable by the badge readers 16 and 18 to further invalidate the use of an expired identification badge 40. However, the host computer 22 typically is programmed to automatically invalidate the identification number of an expired temporary personnel identification badge 40 from the list of numbers authorized to activate the door locks.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A facility access system by which a person is able to access a facility for a defined period of time, said facility access system comprising:
a badge having a picture of the person, an element encoding data that is readable by a lock control system that activates a lock at the facility, and indicia which upon being activated visibly changes in appearance after the defined period of time to indicate expiration of the badge.

2. The facility access system as recited in claim 1 further comprising a device for attaching the badge to one of the person and apparel worn by the person.

3. The facility access system as recited in claim 1 wherein the indicia comprises a first chemical substance which is applied to a surface of the identification badge in a pattern which indicates expiration of the badge and a second chemical substance that is applied to the first chemical substance to activate the indicia.

4. The facility access system as recited in claim 3 wherein the badge further comprises an identification card on which the picture of the person is printed and on which the first chemical substance is applied; and an overlay abutting the identification card and containing the second chemical substance.

5. The facility access system as recited in claim 4 wherein the badge further comprises a transparent outer layer covering the overlay.

6. The facility access system as recited in claim 1 further comprising a designation on the badge of one of a plurality of predefined classes of people who are granted access to the facility.

7. The facility access system as recited in claim 6 wherein the designation indicates that the person is in a class selected from a group consisting of visitors, contractors, employment agency workers, and temporary employees.

8. The facility access system as recited in claim 1 wherein upon visibly changing in appearance the indicia renders the element unreadable.

9. The facility access system as recited in claim 1 wherein the element is selected from a group consisting of a bar code, a magnetic stripe and a radio frequency transponder.

10. The facility access system as recited in claim 1 further comprising a badge reader for reading the element on the badge to obtain the data; and a door lock electrically controlled in response to the badge reader obtaining valid data.

11. The facility access system as recited in claim 10 wherein upon visibly changing in appearance, the indicia renders the element unreadable by the badge reader.

12. The facility access system as recited in claim 1 further comprising a badge reader for reading the element on the badge to obtain the data; and a computer connected to the badge reader to store the data and the time at which the element was read.

13. The facility access system as recited in claim 12 wherein the computer executes software which is part of a time and attendance reporting system which uses the data obtained from reading the element and the time at which the element was read to determine an amount of time that the person was at the facility.

14. A facility access system by which a person is able to access a facility for a defined period of time, wherein the person is classified in one of a plurality of classes of people who may be temporarily present at the facility, said facility access system comprising:
a badge having a designation of the one of the plurality of classes, an element encoding data that is machine readable, and indicia which upon being activated visibly changes in appearance after the defined period of time to indicate expiration of the badge;
reader for reading the element on the badge to obtain the data; and
a computer connected to the badge reader to store the data.

15. The facility access system as recited in claim 14 wherein the badge further includes a picture of the person.

16. The facility access system as recited in claim 14 wherein the indicia comprises a first chemical substance which is applied to a surface of the identification badge in a pattern which indicates expiration of the badge and a second chemical substance that is applied to the first chemical substance to activate the indicia.

17. The facility access system as recited in claim 16 wherein the badge further comprises an identification card containing the designation and the element and on which the first chemical substance is applied; and an overlay abutting the identification card and containing the second chemical substance.

18. The facility access system as recited in claim 17 wherein the badge further comprises a transparent outer layer covering the overlay.

19. The facility access system as recited in claim 14 wherein the element is selected from a group consisting of a bar code, a magnetic stripe, and a radio frequency transponder.

20. The facility access system as recited in claim 14 further comprising a door lock that is electrically operated in response to the data obtained by the reader.

21. The facility access system as recited in claim 14 wherein the computer also stores a time of day at which the element was read.

22. The facility access system as recited in claim 21 wherein the computer executes software which is part of a time and attendance reporting system that uses the data obtained from reading the element and the time of day to determine an amount of time that the person was at the facility.

23. The facility access system as recited in claim 14 wherein upon visibly changing in appearance the indicia renders the element unreadable by the reader.
